(19) United States
(12) Patent Application Publication
(10) Pub. No.: US 2017/0278429 A1
(43) Pub. Date: Sep. 28, 2017

(54) ANATOMICAL ULTRASOUND ACCESS MODEL

(71) Applicant: Boston Scientific Scimed, Inc., Maple Grove, MN (US)

(72) Inventors: Josef Slanda, Milford, MA (US); Christian Ratteree, Barrington, RI (US); Manuel Teixeira, Boston, MA (US)

(21) Appl. No.: 15/460,283

(22) Filed: Mar. 16, 2017

Related U.S. Application Data
(60) Provisional application No. 62/312,967, filed on Mar. 24, 2016.

(51) Int. Cl. G09B 23/28; G09B 23/30

(52) U.S. Cl. CPC G09B 23/286; G09B 23/30

(57) ABSTRACT

The present disclosure relates generally to the field of medical procedures performed using ultrasound imaging for guidance. In particular, the systems and methods of the present disclosure include anatomical models simulating body organs that may be used to train clinicians, students or other medical professionals to access such organs with medical tools in performing interventional procedures using ultrasound guidance.

### CROSS-REFERENCE TO RELATED APPLICATIONS

This application claims the benefit of priority to U.S. Provisional Application Serial No. 62/312,967, filed Mar. 24, 2016, the disclosure of which is herein incorporated by reference in its entirety.

### FIELD

The present disclosure relates generally to the field of medical procedures performed using ultrasound imaging for guidance. The present disclosure provides an anatomical model simulating a body organ for training medical professionals to access a cavity within the organ, in particular the calyces of the kidney, with medical tools using ultrasound guidance.

### BACKGROUND

Conventional procedures involving access to a desired target location in an organ from outside the body, under imaging guidance, present difficulties in determining the position of the access device in three dimensions. Adding to the difficulty is the different tissue characteristics that may be encountered within the same organ or across different organs, such as texture, hardness, firmness, density, compressibility etc. A typical example includes percutaneous kidney procedures in which the calyces are accessed via x-ray using fluoroscopy. There are, however, circumstances in which fluoroscopy is either unavailable, too expensive or simply not preferred (i.e., to minimize x-ray exposure). In these situations, medical professionals may rely on ultrasound for visualizing the kidney architecture during percutaneous procedures. There is a continued need for realistic models, such as a percutaneous ultrasound kidney access model, system and procedures, by which medical professionals may be trained to access organs, such as the internal calyces of the kidney, under actual ultrasound guidance and realistic conditions.

### SUMMARY

In one aspect, the present disclosure relates to a medical training system comprising an anatomical model which simulates the structure of a kidney including a cavity simulating the structure of the calyces, and wherein the anatomical model is formed from a polymeric material. The polymeric material may include, by way of non-limiting example, polyurethane, silicone, rubber and the like. These polymeric materials may include at least one ultrasound-reflecting component. The ultrasound reflecting component may be distributed substantially homogenously throughout the polymeric material. Alternatively, the ultrasound reflecting component may be distributed non-homogenously throughout the polymeric material to simulate tissue regions and/or tissue masses of different densities. The ultrasound-reflecting component of the polymeric material may include a metallic particle and/or metallic powder such as tungsten, brass and/or bronze. In addition, or alternatively, the ultrasound-reflecting component of the polymeric material may include a non-metallic particle such as glass particles, glass beads, crushed glass, ceramic particles, ceramic beads and/or crushed ceramic. At least one target object may be disposed within the cavity of the anatomical model. For example, the target object may include a size and shape approximating a kidney stone. The target object may also include at least one ultrasound-reflecting component, including the metallic and/or non-metallic particles of the polymeric material. The system may further include a length of tubing. A first end of the length of tubing may be attached or otherwise connected through an opening of the anatomical model which simulates an outlet of the kidney calyces. A second end of the length of tubing may be connected to a fluid source, including, for example a syringe. The tubing may include an outflow lumen and an inflow lumen. A fluid pressure indicator may be fluidly connected to the inflow or outflow lumen of the tubing. In addition, or alternatively, a stopcock may be fluidly connected to the inflow or outflow lumen of the tubing. The cavity of the anatomical model may be at least partially filled with a fluid that includes water, saline, contrast agent, synthetic blood, real blood, synthetic urine, real urine and mixtures or combinations thereof.

In another aspect, the present disclosure relates to a medical training system, comprising an anatomical model simulating a body organ, wherein the anatomical model includes a cavity which defines an anatomical structure, and wherein the anatomical model is formed from a polymeric material that includes at least one ultrasound-reflecting component. The simulated body organ may include a kidney, and the anatomical structure may include a calyx. The polymeric material may include, by way of non-limiting example, polyurethane, silicone, rubber and the like. These polymeric materials may include at least one ultrasound-reflecting component. The ultrasound reflecting component may be distributed substantially homogenously throughout the polymeric material. Alternatively, the ultrasound reflecting component may be distributed non-homogenously throughout the polymeric material to simulate tissue regions and/or tissue masses of different densities. The ultrasound-reflecting component of the polymeric material may include a metallic particle and/or metallic powder such as tungsten, brass and/or bronze. Alternatively, the ultrasound-reflecting component of the polymeric material may include a non-metallic particle such as glass particles, glass beads, crushed glass, ceramic particles, ceramic beads and/or crushed ceramic. At least one target object may be disposed within the cavity of the anatomical model. The target object may include a size and shape approximating a kidney stone. The target object may also include at least one ultrasound-reflecting component, including the metallic and/or non-metallic particles of the polymeric material. The system may further include a length of tubing. A first end of the length of tubing may be attached or otherwise connected through an opening of the anatomical model which simulates an outlet of the kidney calyces. A second end of the length of tubing may be connected to a fluid source, including, for example a syringe etc. The tubing may include an outflow lumen and an inflow lumen. A fluid pressure indicator may be fluidly connected to the inflow or outflow lumen of the tubing. In addition, or alternatively, a stopcock may be fluidly connected to the inflow or outflow lumen of the tubing. The cavity of the anatomical model may at least partially filled with a fluid that includes water, saline, contrast agent, synthetic blood, real blood, synthetic urine, real urine and mixtures or combinations thereof.

In yet another aspect, the present disclosure relates to a training method, comprising imaging an anatomical model simulating a body organ using ultrasound; choosing a target location for a medical device within a portion of the cavity defining the anatomical structure; and using the ultrasound imaging to advance the medical device through the polymeric material of the anatomical model such that a distal end of the medical device is positioned at the target location. The anatomical model may simulate a body organ that includes a cavity defining an anatomical structure, wherein the anatomical model is formed from a polymeric material that includes at least one ultrasound-reflecting component. The training method may further include manipulating a target object disposed within the cavity with the medical device, including, by way of non-limiting example, a percutaneous access needle. The training method may further include removing the target object from the cavity using the medical device. The training method may include flowing a fluid into the cavity of the anatomical model at a substantially static pressure prior to visualizing the anatomical model with ultrasound. Alternatively, or in addition, the training method may include flowing a fluid into the cavity of the anatomical model at a substantially static pressure prior while visualizing the anatomical model with ultrasound. The fluid may include water, saline, contrast agent, synthetic blood, real blood, synthetic urine, real urine and mixtures or combinations thereof.

### BRIEF DESCRIPTION OF THE DRAWINGS

Non-limiting embodiments of the present disclosure will be described by way of example with reference to the accompanying figures, which are schematic and not intended to be drawn to scale. In the figures, each identical or nearly identical component illustrated is typically represented by a single numeral. For purposes of clarity, not every component is labeled in every figure, nor is every component of each embodiment of the present disclosure shown where illustration is not necessary to allow those of ordinary skill in the art to understand the disclosure. In the figures:

FIG. 1A provides a schematic surface view of a percutaneous ultrasound kidney access model, in accordance with an embodiment of the present disclosure.

FIG. 1B provides a schematic partial cut-away view of a percutaneous ultrasound kidney access model, in accordance with an embodiment of the present disclosure.

FIG. 1C provides a magnified view of a portion of the wall of the percutaneous ultrasound kidney access model with ultrasound-reflecting components distributed therethrough, in accordance with an embodiment of the present disclosure.

FIG. 2 provides a perspective view of a kidney sculpture, in accordance with an embodiment of the present disclosure.

FIG. 3 provides a perspective view of a calyx sculpture, in accordance with an embodiment of the present disclosure.

FIGS. 4A-4B illustrate the formation of a kidney mold using the kidney sculpture of FIG. 2, in accordance with an embodiment of the present disclosure.

FIGS. 5A-5B illustrate the calyx sculpture of FIG. 3 positioned within the kidney mold of FIGS. 4A-4B, in accordance with an embodiment of the present disclosure.

FIG. 6 illustrates the calyx sculpture inside a three-dimensional anatomical model, in accordance with an embodiment of the present disclosure.

FIG. 7 illustrates the three-dimensional anatomical model of FIG. 6 after removal of the calyx sculpture, in accordance with an embodiment of the present disclosure.

The drawings are intended to depict only typical or exemplary embodiments of the disclosure and should not be considered as limiting the scope of the disclosure. The disclosure will now be described in greater detail with reference to the accompanying drawings.

### DETAILED DESCRIPTION OF THE PREFERRED EMBODIMENTS

The disclosure is not limited to the particular embodiments described, as such may vary. The terminology used herein is for the purpose of describing particular embodiments only, and is also not intended to be limiting beyond the scope of the appended claims. Unless defined otherwise, all technical and scientific terms used herein have the same meaning as commonly understood by one or ordinary skill in the art to which the present disclosure belongs. Although any methods and materials similar or equivalent to those described herein may also be used in the practice or testing of the present disclosure, a limited number of the exemplary methods and materials are described herein. Finally, although embodiments of the present disclosure are described with specific reference to percutaneous ultrasound mediated access to the kidney, it should be appreciated that the systems and methods described herein may be applicable to ultrasound mediated access to other organs and/or internal locations within the body.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components and/or groups thereof.

The phrase “and/or,” as used herein in the specification and in the claims, should be understood to mean “either or both” of the elements so conjoined, i.e., elements that are conjunctively present in some cases and disjunctively present in other cases. Other elements may optionally be present other than the elements specifically identified by the “and/or” clause, whether related or unrelated to those elements specifically identified unless clearly indicated to the contrary. Thus, as a non-limiting example, a reference to “A and/or B,” when used in conjunction with open-ended language such as “comprising” can refer, in one embodiment, to A without B (optionally including elements other than B); in another embodiment, to B without A (optionally including elements other than A); in yet another embodiment, to both A and B (optionally including other elements), etc.

As used herein in the specification and in the claims, “or” should be understood to have the same meaning as “and/or” and shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.”

The present disclosure relates to a three dimensional training system which allows medical professionals to practice accessing a target location in an organ from outside the body under imaging guidance. The present disclosure relates to a percutaneous ultrasound kidney access model which allows medical professionals to practice accessing the internal calyces of the kidney with a variety of medical tools using ultrasound guidance. For example, the model may allow the medical professional to practice the proper angle and placement of medical tools (e.g., introducer sheaths, needles, graspers etc.) through the wall of the kidney model to access the internal calyces using ultrasound guidance. Once the medical tool(s) are properly positioned, the medical professional may also practice manipulating and/or removing target objects, such as “kidney stones,” from within the calyces. The kidney model may be utilized by itself or included within a model human torso to more accurately simulate an actual surgical setting.

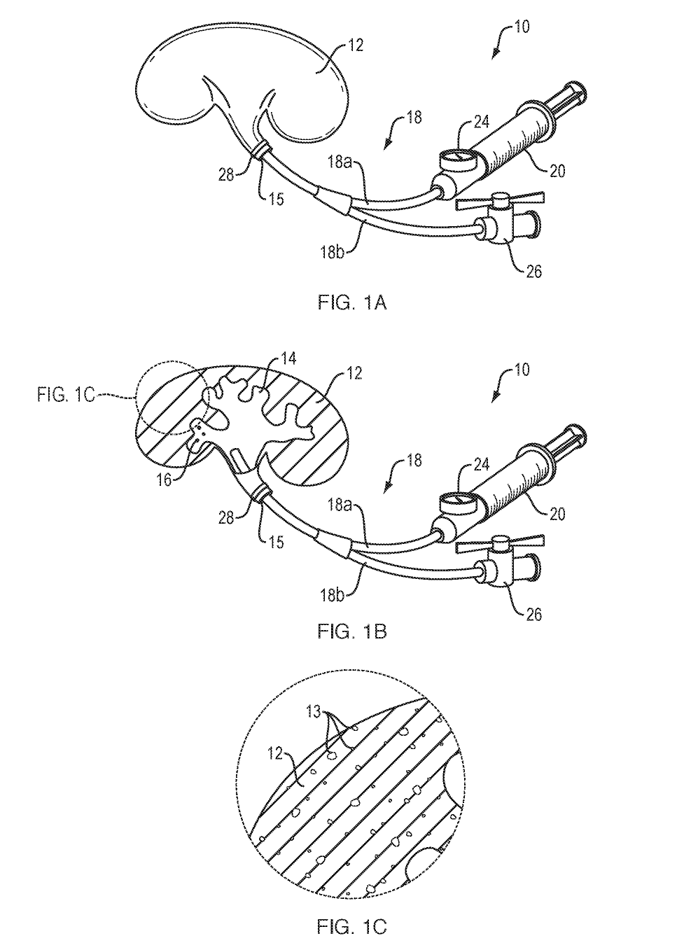

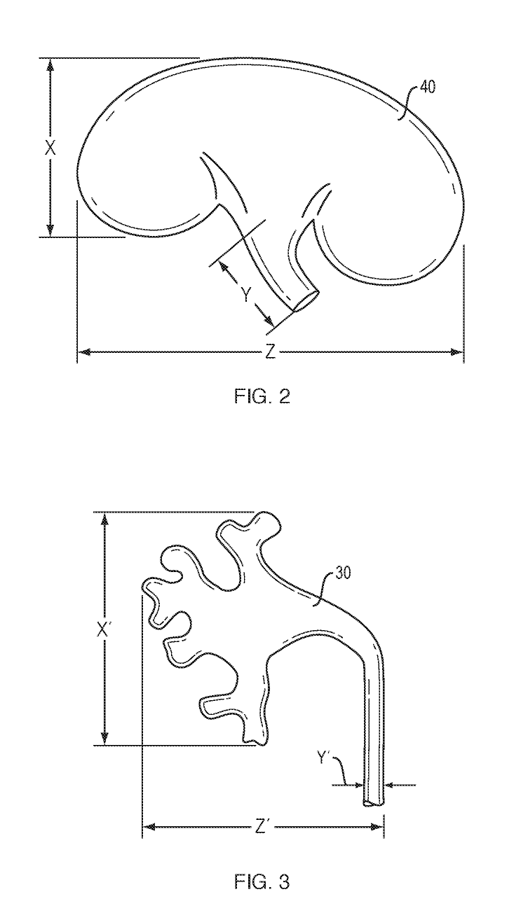

FIG. 1A illustrates a medical training system 10 comprising an anatomical model 12 simulating a body organ. The simulated body organ may include, by way of non-limiting example, a kidney. Referring to FIG. 1B, the anatomical model 12 may further include a cavity defining an anatomical structure 14 within the simulated body organ. For example, in an embodiment in which the simulated body organ is a kidney, the anatomical structure 14 within the anatomical model 12 may include a calyx. It will be appreciated that the dimensions (i.e., size, shape etc.) of the anatomical model 12 and anatomical structure 14 may approximate the size of the corresponding organ within an individual patient. In one embodiment, the size of the anatomical model may be decreased to mimic the body organ of a smaller or younger patient, and increased to mimic the body organ of a larger or older patient. In another embodiment, the size of the anatomical model may be increased as compared to the in vivo organ (e.g., increased 2-fold or more; 3-fold or more; increased 10-fold or more) for training or demonstration purposes. For example, a medical student or surgical resident may benefit from practicing a medical procedure on a larger version of the anatomical model 12 and progress to smaller versions of the anatomical model as their level of skill increases. Similarly, the size of the anatomical model may be decreased as compared to the in vivo organ (e.g., decreased by 2-fold or more; 3-fold or more; 10-fold or more). Such a reduction is size may serve a variety of useful purposes, including, for example, to reduce the cost/amount of materials required to make each anatomical model and/or to accommodate space constraints within a teaching classroom. In yet another embodiment, the dimensions and/or physical characteristics of the anatomical model may be adjusted to mimic an unhealthy, diseased or otherwise atypical organ which the medical professional may not have encountered during previous procedures.

The anatomical model 12 may be formed from a variety of pliable and needle-penetrable materials that mimic one or more physical characteristics (i.e., color, texture, hardness, density, firmness, compressibility etc.) of the body organ as it exists within a patient. The skilled artisan will recognize that the anatomical model may be formed in part or entirely from a variety of natural or synthetic polymeric materials, e.g., polyurethane, silicone, rubber and the like. The self-sealing nature of these polymeric materials may allow the anatomical model 12 to undergo multiple needle piercings before the structural integrity is compromised (i.e., excess leakage) to the point that the anatomical model is no longer workable.

Referring again to FIG. 1C, the anatomical model 12 may include at least one ultrasound-reflecting component 13 distributed substantially homogenously (i.e., uniformly or evenly) throughout the polymeric material. Alternatively, or in addition, the ultrasound reflecting component may be distributed non-homogenously throughout the polymeric material to simulate tissue regions and/or tissue masses of different densities. Examples of suitable ultrasound-reflecting materials that may be incorporated in the polymeric material include, but are not limited to, glass (e.g., glass particles, glass beads and/or crushed glass), ceramics (e.g., ceramic particles, ceramic beads and/or crushed ceramic), metallic particles and/or metallic powders (e.g., tungsten, brass, nickel, titanium and bronze 80 to 240 grit.)

Referring again to FIG. 1B, the anatomical structure 14 within the anatomical model 12 may further include one or more target objects 16 configured to mimic a foreign body or other undesirable material. For example, the target objects 16 may include dimensions (i.e., size and shape) and compositions that mimic a kidney stone. The skilled artisan will recognize that the target objects 16 may be synthetically formed from a variety of materials, including, for example, calcium oxalate, calcium phosphate, uric acid, struvite, cystine and or xanthine. In one embodiment, the target objects 16 may include at least one ultrasound-reflecting component as outlined above. In another embodiment, the target objects 16 may include artificial kidney stones made from “BegoStone” compound or actual kidney stones retrieved from a patient during a medical procedure.

As illustrated in FIGS. 1A and 1B, the medical training system 10 may optionally include a fluid source 20 (e.g., syringe etc.), and the model have an opening adapted or configured to be fluidly connected to the anatomical structure 14 of anatomical model 12 by a length of tubing 18. As best illustrated by FIG. 1B, a distal end of the tubing 18 may be extend into a portion of the anatomical structure through an opening 15 within the anatomical model 12. The tubing 18 may be secured to the anatomical model by one or more clamps 28. In one embodiment, the length of tubing 18 may include an inflow lumen 18a and an outflow lumen 18b. A fluid (not shown) may flow at a substantially static pressure from the fluid source 20 into the anatomical structure 14 through the inflow lumen 18a, and flow from the anatomical structure 14 through the outflow lumen 18b. The medical training system 10 may further include a pressure indicator 24 fluidly connected to the inflow lumen 18a at a location between the fluid source 20 and anatomical model 12. The pressure indicator 24 may allow a medical professional to circulate fluid through the anatomical structure 14 at a physiological pressure, e.g., approximately 10-15 psi (e.g., approximately 68-103 kPa), to simulate the in vivo conditions within the anatomical model during a training procedure. A rotatable stopcock 26 may be connected to the outflow lumen 18b to allow the medical professional to more precisely control the flow of fluids through the medical training system 10. A variety of suitable fluids may be circulated through the medical training system 10, including, for example, water, saline, contrast agent, synthetic blood, real blood, synthetic urine, real urine and mixtures or combinations thereof.

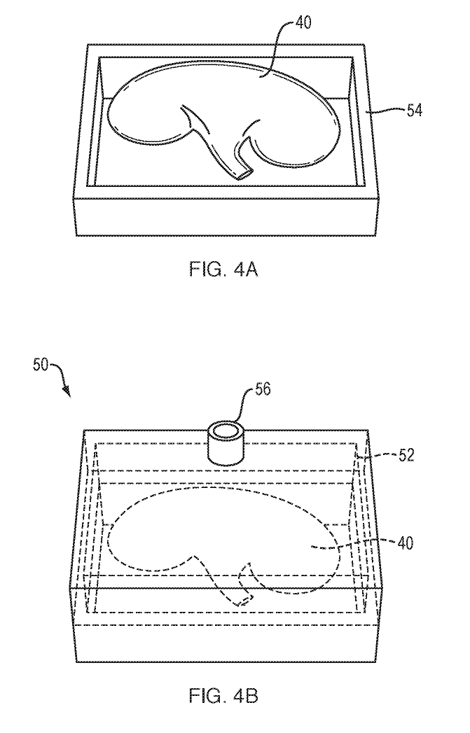

FIGS. 2-7 illustrate the steps involved in forming the anatomical model 12 and anatomical structure 14 of the present disclosure. Referring to FIG. 2, a kidney model 40 (i.e., sculpture) is formed using modeling clay. Without intending to limit the present disclosure to specific dimensions, in one embodiment the kidney model 40 of the present disclosure may generally have an overall length Z of approximately 5.50 inches (i.e., approximately 14.0 cm), an overall width X of approximately 2.50 inches (i.e., approximately 6.35 cm) and a ureter portion having a length Y of approximately 1.75 inches (i.e., 4.50 cm). Referring to FIG. 3, a calyx model 30 (i.e., sculpture) may be formed using modeling clay. Again, without intending to limit the present disclosure to specific dimensions, in one embodiment a calyx model 30 of the present disclosure may generally have an overall length Z′ of approximately 3.00 inches (i.e., approximately 7.60 cm), an overall width X′ of approximately 2.50 inches (i.e., approximately 6.35 cm) and a ureter portion having a width Z′ of approximately 0.025 inches (i.e., approximately 0.064 cm). Referring to FIGS. 4A-4B, the kidney model 40 of

FIG. 2 is placed within a mold box 50 that includes separable top and bottom portions 52, 54. A resin (not shown) is poured into a port 56 within the top portion 52 of the mold box 50 such that the kidney model 40 is completely and uniformly encompassed by the resin.

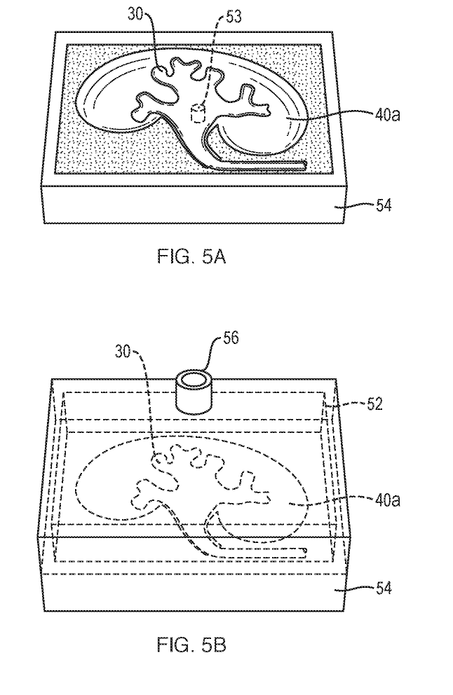

After the resin has cured, the mold box 50 is opened and the kidney model 40 removed such that the cured resin forms a mold 40a (i.e., outline or negative) of the kidney model 40, with substantially equal portions of the mold 40a being present in the top and bottom portions 52, 54 of the mold box 50 (FIGS. 5A-5B). A resin mold of the calyx model may likewise be formed using a mold box as described for the kidney model above. The resin mold of the calyx model may then be filled with wax to form a calyx model 30.

Referring to FIG. 5A, the wax calyx model 30 is suspended within the mold of the kidney model in the bottom portion 54 of the mold box 50. In one embodiment, the wax calyx model 30 may be elevated on a post 53 such that approximately one half of the wax calyx model 30 lies within the kidney mold in the bottom portion 54 of the mold box 50, and approximately one half of the wax calyx model 30 extends above the bottom portion 54 of the mold box 50. The top portion 52 of the mold box 50 is then placed on top of the bottom portion 54 and secured together with clamps (FIG. 5B). A suitable flowable polymeric material (as discussed above) is then poured into the mold box 50 through the port 56 such that the mold 40a is filled and the wax calyx model 30 is completely and uniformly encompassed.

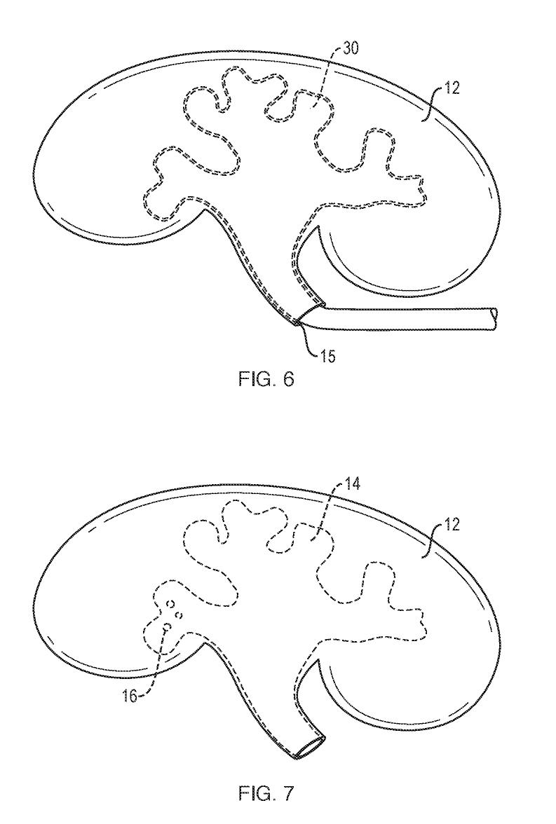

The mold box 50 is then placed into a pressure chamber at 24-30 psi (e.g., approximately 165-206 kPa) for 10-12 hours. Referring to FIG. 6, the anatomical model 12 is then removed from the mold box and placed in an oven at 100° C. such that the wax calyx model 30 melts and flow out of the anatomical model 12 through an opening 15. Excess wax may be flushed from within the anatomical model 12 using hot water to provide anatomical structure 14 (FIG. 7). Excess polymeric material may be removed from the outer surface of the anatomical model 12 using a cutting tool (e.g., scalpel, razor blades etc.) and the surface of the anatomical model cleaned using alcohol wipes. After the wax has been sufficiently removed, one or more target objects 16 may be introduced into the anatomical structure 14 through the opening 15. Alternatively, the target objects 16 may be incorporated into the wax model of the calyx during its manufacturing such that the target objects are left behind within the anatomical structure after the wax has been removed.

Referring again to FIGS. 1A-1B, in practice a medical professional would flow a fluid from the fluid source 20 through the inflow lumen 18a of the tubing 18 into the anatomical structure 14 of the anatomical model 12 at a physiological pressure (e.g., 17-20 psi in the case of the kidney model). The desired fluid pressure may be adjusted and maintained within the medical training system by opening and/or closing the stopcock 26 attached to the outflow lumen 18b. The anatomical model 12 may then be imaged using an ultrasound transducer as is commonly known in the medical field. In general, the ultrasound-reflecting component 13 (FIG. 1C) distributed throughout the anatomical model 12, and any target objects 16 located within the anatomical structure 14, are visualized as lightly colored (i.e., light gray) images on the ultrasound display, while the fluid within the anatomical structure 14 provides a dark colored (i.e., dark gray) image of the calyx. The anatomical model 12 may then be penetrated using a needle (not shown), such as a percutaneous access needle, which may be ultrasound-visible available from Boston Scientific, and advanced to the desired location within the anatomical structure 14 using ultrasound guidance. In addition, or alternatively, the medical professional may practice removal of the target objects 16 through the “ureter” of the anatomical model 12 by advancing one or more medical tools (i.e., baskets, graspers etc.) into the anatomical structure 14 through the inflow lumen 18a of the tubing 18.

All of the compositions and/or methods disclosed and claimed herein can be made and executed without undue experimentation in light of the present disclosure. While the compositions and methods of the present disclosure have been described in terms of preferred embodiments, it will be apparent to those of skill in the art that variations can be applied to the compositions and/or methods and in the steps or in the sequence of steps of the method described herein without departing from the concept, spirit and scope of the present disclosure. All such similar substitutes and modifications apparent to those skilled in the art are deemed to be within the spirit, scope and concept of the disclosure as defined by the appended claims.

What is claimed is:

1. A medical training system, comprising:
an anatomical model simulating a body organ, the anatomical model including a cavity defining an anatomical structure, wherein the anatomical model is formed from a polymeric material that includes at least one ultrasound-reflecting component.

2. The medical training system of claim 1, wherein the simulated body organ is a kidney.

3. The medical training system of claim 1, wherein the anatomical structure is a calyx.

4. The medical training system of claim 1, wherein the polymeric material is selected from the group consisting of polyurethane, silicone and rubber.

5. The medical training system of claim 1, wherein the ultrasound-reflecting component includes a metallic particle selected from the group consisting of tungsten, brass and bronze.

6. The medical training system of claim 1, wherein the ultrasound-reflecting component includes a metallic powder selected from the group consisting of tungsten, brass and bronze.

7. The medical training system of claim 1, wherein the ultrasound-reflecting component includes a particle selected from the group consisting of glass particles, glass beads, crushed glass, ceramic particles, ceramic beads and crushed ceramic.

8. The medical training system of claim 1, wherein the ultrasound-reflecting component is distributed substantially homogenously throughout the polymeric material.

9. A medical training system, comprising:
an anatomical model simulating a structure of a kidney including calyces, the anatomical model including a cavity simulating the structure of the calyces, wherein the anatomical model is formed from a polymeric material.

10. The medical training system of claim 9, further including at least one target object disposed within the cavity of the anatomical model.

11. The medical training system of claim 10, wherein the target object includes a size and shape approximating a kidney stone.

12. The medical training system of claim 10, wherein the target object includes at least one ultrasound-reflecting component.

13. The medical training system of claim 9, wherein the system includes tubing and the anatomical model includes an opening to the cavity simulating an outlet of the kidney calyces, the opening connected to a first end of a length of the tubing.

14. The medical training system of claim 13, wherein the tubing includes an outflow lumen and an inflow lumen.

15. The medical training system of claim 13, wherein the system includes a fluid source connected to a second end of a length of the tubing.

16. A training method, comprising:
imaging an anatomical model simulating a body organ using ultrasound, wherein the anatomical model simulates a body organ including a cavity defining an anatomical structure, wherein the anatomical model is formed from a polymeric material that includes at least one ultrasound-reflecting component;
choosing a target location for a medical device within a portion of the cavity defining the anatomical structure; and
using the ultrasound imaging to advance the medical device through the polymeric material of the anatomical model such that a distal end of the medical device is positioned at the target location.

17. The training method of claim 16, further comprising manipulating a target object disposed within the cavity with the medical device.

18. The training method of claim 16, wherein the medical device includes a percutaneous access needle.

19. The training method of claim 17, further comprising removing the target object from the cavity using the medical device.

20. The training method of claim 16, further comprising flowing a fluid into the cavity of the anatomical model at a substantially static pressure while visualizing the anatomical model with ultrasound.
